(19) United States
(12) Patent Application Publication
(10) Pub. No.: US 2018/0118457 A1
(43) Pub. Date: May 3, 2018

(54) Garbage Basket with Garbage Bag Penetrator Members

(71) Applicant: Bruce Seiffert, Drummond, WI (US)

(72) Inventor: Bruce Seiffert, Drummond, WI (US)

(21) Appl. No.: 15/339,498

(22) Filed: Oct. 31, 2016

(51) Int. Cl. B65F 1/06

(52) U.S. Cl. CPC B65F 1/06

(57) ABSTRACT

The invention is directed to a garbage container used for receiving a plastic garbage bag and holding the plastic trash bag in place during use. The plastic basket includes a base bottom portion and an upstanding side wall portion surrounding and continuing the base bottom portion to form an internal cavity. The side wall portion includes on the opposite end of the base bottom portion a convex flange protruding away from the internal cavity. The convex flange includes at least one protuberant wedge formed along at least one section of the convex flange. At least one protuberant wedge shaped in a manner to receive the open ended upper section of the plastic garbage bag.

### TECHNICAL FIELD

The present invention relates to the field of labor saving garbage baskets. Specifically, the invention relates to a garbage basket with garbage bag penetrators formed on the garbage basket.

### BACKGROUND

Garbage baskets and plastic garbage bags are often used together so that the lining of the basket remains clean and garbage can be easily removed and disposed. However, a problem with this traditional combination is that the garbage bag is often placed in the basket with the open end section of the bag pulled over and around the basket open ended rim and as the basket is used the garbage bag becomes easily dislodged from its position. As such, either the basket gets used with the improperly placed garbage bag or someone has to reposition the bag to its proper position. There have been attempts by others to produce garbage baskets that can solve this issue but all appear to lack in one area or another and only offer products of inferior quality.

A prime example would be found in U.S. Pat. No. 4,834,260 issued to Strawder. However, although Strawder addresses similar issues, Strawder provides a solution that may not be the most effective. Strawder, describes a trash container that includes affixed gripping penetrators along a circumference of the container's open ended rim that can be utilized to keep the placed garbage bag in position. However, a problem with this solution is that Strawder discloses a multi-part system that includes a trash container and an after market, or after manufacture, affixed penetrator system. As such, the solution is less cost effective, less reliable, and less efficient, or stated differently more time consuming to manage.

As such, there is a need for a garbage basket that can maintain and keep the position of placed garbage bags in an efficient, reliable, and more cost effective manner.

### SUMMARY

The example embodiments presented herein meet the above-identified needs by providing an improved garbage container for containing garbage placed in the container when used with a plastic garbage bag.

According to an embodiment of this invention, a garbage container used for receiving a plastic trash bag, defined herein as having a sealed bottom section and a sidewall section with an open ended upper section, is presented wherein the container comprises a plastic basket that includes a base bottom portion and an upstanding side wall portion surrounding and continuing the base bottom portion to form an internal cavity that receives the plastic trash bag. The side wall portion includes on the opposite end of the base bottom portion a convex flange protruding away from the internal cavity and at least one protuberant wedge formed along at least one section of the convex flange. At least one wedge shaped protuberant will receive the open ended upper section of the plastic garbage bag.

According to another embodiment of this invention, the garbage basket with garbage bag penetrators is square and at least one protuberant wedge is formed along each side. In this embodiment, the protuberant wedges are triangular shape. Alternatively in this embodiment, at least one protuberant wedge includes two wedges that are rounded in shape and two that are triangular in shape.

According to another embodiment of this invention, the garbage basket with garbage bag penetrators with the at least one protuberant wedge, comprises only two protuberant wedges and the two wedges are triangular in shape. Alternatively in this embodiment, the garbage basket with garbage bag penetrators with at least one protuberant wedge comprises only two protuberant wedge and the two wedges are rounded in shape.

### BRIEF DESCRIPTION OF THE DRAWINGS

FIG. 1 is a side view of a garbage basket with garbage penetrators according to an embodiment of the invention.

FIG. 2 is a perspective view of a garbage basket with garbage penetrators according to an embodiment of the invention.

### DETAILED DESCRIPTION OF THE PRESENTLY PREFERRED EMBODIMENTS

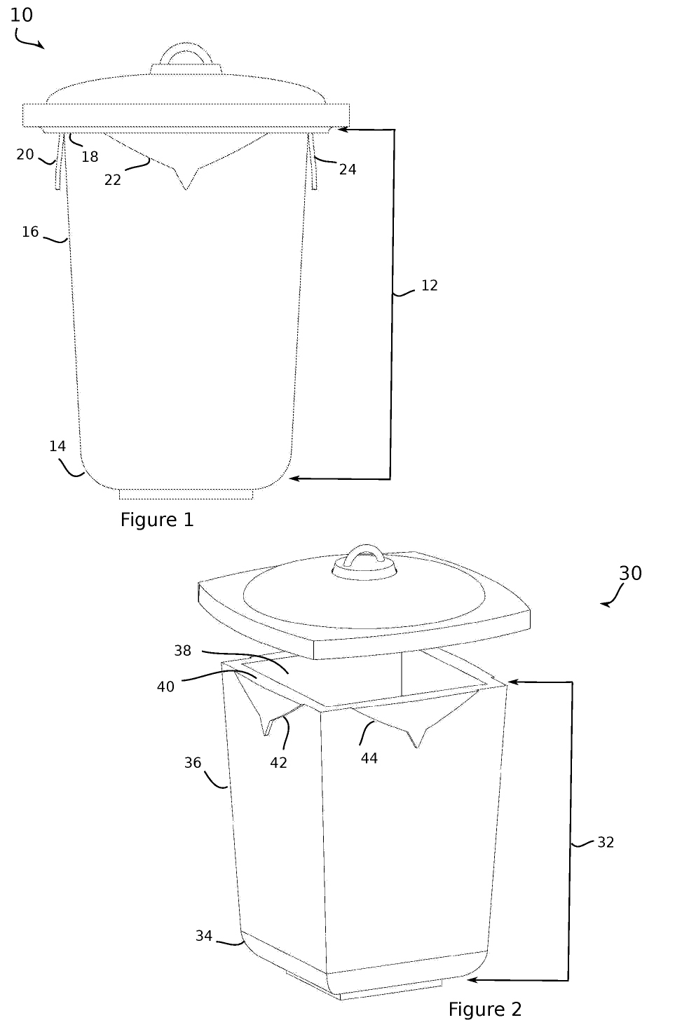

Referring to FIG. 1, illustrated is a garbage container for receiving a plastic trash bag and denoted generally as 10. The plastic garbage bag would have a sealed bottom section and a sidewall section with an open ended upper section. The garbage container 10 comprises a plastic basket 12 that includes a base bottom portion 14 and an upstanding side wall portion 16 surrounding and continuing the base bottom portion of 12 to form an internal cavity. The side wall portion 16 includes on the opposite end of the base bottom portion 14 a convex flange 18, alternatively a flat rim, protruding away from the internal cavity and at least one protuberant wedge 20,22,24 formed below at least one section of the convex flange 18, or alternatively the flat rim, and along and on the sidewall portion 16.

At least one protuberant wedge 20, 22, 24 may be formed on the flange 18 and protrudes downward to either a spiked wedge shape or a rounded wedge shape or a combination thereof. Alternatively, at least one protuberant wedge 20, 22, 24 may be formed only on the sidewall portion 16 with a section of the wedges having a wedged section between sidewall and wedge. The wedge shapes can also be spiked or rounded. It should also be understood that the wedges 20, 22, 24 may be formed on the flange 18 and sidewall portion 16. The plastic garbage bag when placed in the basket can have its open ended rim section slipped under the free space of the protruding wedges 20, 22, 24 between the relative sidewall portion and the protruding wedge.

Referring now to FIG. 2, illustrated is an alternative garbage container for receiving a plastic trash bag and denoted generally as 30. The plastic garbage bag would have a sealed bottom section and a sidewall section with an open ended upper section. The garbage container 30 comprises a plastic basket 32 that includes a base bottom portion 34 and an upstanding side wall portion 36 surrounding and continuing the base bottom portion 32 to form an internal cavity 38. The side wall portion 16 includes on the opposite end of the base bottom portion 14 a flat rim 40. Formed along sections below the flat rim 40 on at least one section of each sidewall 36 are protruding wedges 42, 44, e.g. all four sidewall sections may have formed thereon or only two sections may have formed thereon a protruding wedge. The wedges 42, 44 may also be either spiked, i.e. triangular, or rounded. The plastic garbage bag when placed in the basket can have its open ended rim section slipped under the free space of the protruding wedges 42, 44 between the relative sidewall portion and the protruding wedge. The plastic bag can then being secured for use.

Plastic baskets described in reference to FIGS. 1 and 2 can be made from any type of commercially available plastic suitable for household use. The plastic baskets and the formed wedges are molded together as one unit using traditional injection molding processes. Alternative techniques such as 3-D printing may also be employed. However, it is the singular unit that provides greatest benefit.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A garbage container used for receiving a plastic trash bag, the plastic garbage bag having a sealed bottom section and a sidewall section with an open ended upper section, the container comprising:
a plastic basket that includes a base bottom portion and an upstanding side wall portion surrounding and continuing the base bottom portion to form an internal cavity, the side wall portion including on the opposite end of the base bottom portion a convex flange protruding away from the internal cavity, and at least one protuberant wedge formed along at least one section of the convex flange; and
at least one wedge shaped protuberant will receive the open ended upper section of the plastic garbage bag.

2. The garbage basket with garbage bag penetrators as recited in claim 1 wherein plastic basket is square and at least one protuberant wedge is formed along each side.

3. The garbage basket with garbage bag penetrators as recited in claim 2 wherein the protuberant wedge is a triangular shape.

4. The garbage basket with garbage bag penetrators as recited in claim 2 wherein at least one protuberant wedge includes two wedges that are rounded in shape and two that are triangular in shape.

5. The garbage basket with garbage bag penetrators as recited in claim 1 wherein at least one protuberant wedge includes two wedges that are triangular in shape.

6. The garbage basket with garbage bag penetrators as recited in claim 1 wherein at least one protuberant wedge includes two wedges that are rounded in shape.
